(19) United States
(12) Patent Application Publication
(10) Pub. No.: US 2022/0026648 A1
(43) Pub. Date: Jan. 27, 2022

(54) OPTICAL CONNECTOR, OPTICAL CABLE, AND ELECTRONIC DEVICE

(71) Applicant: SONY GROUP CORPORATION, TOKYO (JP)

(72) Inventors: HIROSHI MORITA, TOKYO (JP); KAZUAKI TOBA, KANAGAWA (JP); MASANARI YAMAMOTO, TOKYO (JP); YUSUKE OYAMA, TOKYO (JP)

(21) Appl. No.: 17/309,523

(22) PCT Filed: Nov. 21, 2019
(86) PCT No.: PCT/JP2019/045586

§ 371 Date: Jun. 3, 2021

(51) Int. Cl. G02B 6/42; G02B 6/44

(52) U.S. Cl. CPC G02B 6/4203; G02B 6/44; G02B 6/4204

(57) ABSTRACT

The coupling loss of optical power on a reception side due to an axis deviation on a transmission side is satisfactorily mitigated. A connector body including a first lens and a second lens is provided. The first lens converges light emitted from a light-emitting body. The second lens shapes and emits the light converged by the first lens. For example, the second lens shapes light emitted from the first lens into collimated light. The focal distance of the second lens can be increased while increase in the distance from the light-emitting body to the second lens is inhibited and the diameter of light from the light-emitting body is restricted so as to be within the diameter of the second lens. The coupling loss of optical power on the reception side due to the axis deviation on the transmission side can be mitigated.

### TECHNICAL FIELD

The present technology relates to an optical connector, an optical cable, and an electronic device. Specifically, the present technology relates to, for example, an optical connector capable of mitigating optical power loss due to axis deviation.

### BACKGROUND ART

Conventionally, an optical connector of optical coupling type, a so-called optical coupling connector has been proposed (e.g., see Patent Document 1). In a method of an optical coupling connector, a lens is mounted on the tip of each optical fiber in accordance with an optical axis, and an optical signal is transmitted between facing lenses as parallel light. In the optical coupling connector, optical fibers are optically coupled in a non-contact state, which inhibits adverse effects on transmission quality due to, for example, trash entering the space between the optical fibers, and eliminates the need for frequent and careful cleaning.

### CITATION LIST

### Patent Document

Patent Document 1: WO 2017/056889

### SUMMARY OF THE INVENTION

### Problems to be Solved by the Invention

An optical connector of optical coupling type has a disadvantage that, for example, in a case where an optical fiber has an exceedingly small core diameter in a single mode, deviation of a lens optical axis and an optical-fiber optical path on a transmission side, that is, axis deviation leads to significant coupling loss of optical power on a reception side.

An object of the present technology is to satisfactorily mitigate the coupling loss of optical power on the reception side due to an axis deviation on the transmission side.

### Solutions to Problems

A concept of the present technology relates to

an optical connector including

a connector body including a first lens that converges light emitted from a light-emitting body and a second lens that shapes light converged by the first lens and emits the light.

In the present technology, the connector body including the first lens and the second lens is provided. Here, the first lens converges light emitted from the light-emitting body. Furthermore, the second lens shapes and emits the light converged by the first lens. For example, the first lens may include one or two or more lenses. Furthermore, for example, the second lens may shape light emitted from the first lens into collimated light.

As described above, in the present technology, the first lens converges light emitted from the light-emitting body, and the second lens shapes and emits the converged light. Therefore, coupling loss of optical power on a reception side due to axis deviation on a transmission side can be mitigated by inhibiting the increase in distance from the light-emitting body to the second lens, restricting the diameter of light from the light-emitting body such that the diameter is within the diameter of the second lens, and increasing the focal distance of the second lens.

Note that, in the present technology, for example, the connector body may have sealed space, and the first lens may be positioned in the sealed space. Positioning the first lens in the sealed space in such a way prevents, for example, mote and dirt from attaching to the surface of the first lens.

Furthermore, in the present technology, for example, the connector body may include a first optical unit on which light emitted from the light-emitting body is incident and a second optical unit including the second lens. In this case, for example, the first lens may be included in the first optical unit and/or the second optical unit. The connector body including the first and second optical units as described above can facilitate, for example, manufacturing of the first lens.

Furthermore, in the present technology, for example, the light-emitting body may be an optical fiber, and the connector body may have an insertion hole into which an optical fiber is inserted. Such a connector body having an insertion hole into which an optical fiber serving as a light-emitting body is inserted can facilitate optical-axis alignment of the optical fiber and the first lens.

In this case, for example, the first lens may be placed at the bottom portion of the insertion hole. The first lens placed at the bottom portion of the insertion hole as described above can increase the precision of the optical-axis alignment of the optical fiber and the first lens. Then, in this case, a ferrule into which the optical fiber is inserted and fixed may be inserted into the insertion hole. This facilitates keeping a certain distance between the optical fiber and the first lens in an optical-axis direction.

Furthermore, in this case, for example, the connector body may include an optical path changing unit that changes an optical path toward a bottom portion of the insertion hole, and light emitted from the optical fiber may be incident on the first lens after the optical path is changed by the optical path changing unit. The optical path changing unit provided in such a way can increase the degree of freedom in design. Then, in this case, a ferrule into which the optical fiber is inserted and fixed may be inserted into the insertion hole. This facilitates keeping a certain distance between the optical fiber and the optical path changing unit in the optical-axis direction.

Furthermore, in the present technology, for example, the light-emitting body may be a light emitting element that converts an electric signal into an optical signal. Forming the light-emitting body as a light emitting element in such a way eliminates the need for an optical fiber at the time when an optical signal is transmitted from the light emitting element, which can reduce costs.

In this case, for example, the light emitting element may be connected to the connector body, and light emitted from the light emitting element may be incident on the first lens without change of an optical path. Furthermore, for example, the connector body may include an optical path changing unit that changes an optical path, the light emitting element may be fixed on a substrate, and light emitted from the light emitting element may be incident on the first lens after the optical path is changed by the optical path changing unit. Such configuration in which light from the light emitting element fixed to the substrate is incident on the first lens after the optical path is changed by the optical path changing unit facilitates mounting, and can increase the degree of freedom in design.

Furthermore, in the present technology, for example, the connector body may include a light-transmitting material, and may integrally have the first lens and the second lens. In this case, the precision of the positions of the first lens and the second lens with respect to the connector body can be increased.

Furthermore, in the present technology, for example, the connector body may include a plurality of combinations of the first lens and the second lens. Such configuration in which the connector body includes a plurality of combinations of the first lens and the second lens can facilitate the increase in the number of channels.

Furthermore, in the present technology, for example, the connector body may include a recessed light emitting portion, and the second lens may be positioned at the bottom portion of the light emitting portion. The second lens positioned at the bottom portion of the light emitting portion in such a way can prevent the surface of the second lens from being scratched by carelessly hitting against, for example, a connector on the other side.

Furthermore, in the present technology, for example, the connector body may integrally include, on a front surface side, a projecting or recessed position restricting portion that is used for position alignment with a connector on a side to be connected. This facilitates optical-axis alignment at the time of connection with the connector on the other side.

Furthermore, in the present technology, for example, a light-emitting body may be further provided. Such configuration with a light-emitting body can save the trouble of mounting the light-emitting body.

Furthermore, another concept of the present technology relates to

an optical cable including an optical connector serving as a plug,

in which the optical connector includes

a connector body including a first lens that converges light emitted from a light-emitting body and a second lens that shapes light converged by the first lens and emits the light.

Furthermore, another concept of the present technology relates to

an electronic device including an optical connector serving as a receptacle,

in which the optical connector includes

a connector body including a first lens that converges light emitted from a light-emitting body and a second lens that shapes light converged by the first lens and emits the light.

### BRIEF DESCRIPTION OF DRAWINGS

FIG. 1 outlines an optical coupling connector.

FIG. 2 illustrates a method of reducing the coupling loss of optical power on a reception side due to an optical-axis deviation on a transmission side.

FIG. 3 illustrates occurrence of the coupling loss of optical power due to an optical-axis deviation in an optical coupling connector using collimated light and a method of reducing the coupling loss.

FIG. 4 illustrates a configuration example of an electronic device and optical cables as an embodiment.

FIG. 5 is a perspective view illustrating one example of a transmission side optical connector and a reception side optical connector, which constitute an optical coupling connector.

FIG. 6 is a perspective view illustrating one example of the transmission side optical connector and the reception side optical connector, which constitute the optical coupling connector.

FIG. 7 is a perspective view illustrating a state in which a first optical unit and a second optical unit, which constitute a connector body, are separated.

FIG. 8 is a perspective view illustrating a state in which the first optical unit and the second optical unit, which constitute the connector body, are separated.

FIG. 9 is a cross-sectional view illustrating one example of the transmission side optical connector.

FIG. 10 is a cross-sectional view illustrating one example of the reception side optical connector.

FIG. 11 is a cross-sectional view illustrating one example of a state in which the transmission side optical connector and the reception side optical connector are connected.

FIG. 12 illustrates one example of the configuration of the transmission side optical connector for simulating coupling efficiency of light.

FIG. 13 is a graph illustrating one example of a simulation result of the coupling efficiency of light.

FIG. 14 is a cross-sectional view illustrating a transmission side optical connector in another configuration example 1.

FIG. 15 is a cross-sectional view illustrating a transmission side optical connector in another configuration example 2.

FIG. 16 is a cross-sectional view illustrating a transmission side optical connector in another configuration example 3.

FIG. 17 is a cross-sectional view illustrating a transmission side optical connector in another configuration example 4.

FIG. 18 is a cross-sectional view illustrating a transmission side optical connector in another configuration example 5.

FIG. 19 is a cross-sectional view illustrating a transmission side optical connector in another configuration example 6.

FIG. 20 is a cross-sectional view illustrating a transmission side optical connector in another configuration example 7.

FIG. 21 is a cross-sectional view illustrating a transmission side optical connector in another configuration example 8.

FIG. 22 is a cross-sectional view illustrating a transmission side optical connector in another configuration example 9.

FIG. 23 is a cross-sectional view illustrating a transmission side optical connector in another configuration example 10.

FIG. 24 illustrates occurrence of the coupling loss of optical power due to an optical-axis deviation in an optical coupling connector using convergent light (light bent in a light collecting direction) and a method of reducing the coupling loss.

### MODE FOR CARRYING OUT THE INVENTION

An embodiment for carrying out the invention (hereinafter referred to as an “embodiment”) will be described below. Note that the description will be given in the following order.

1. Embodiment

2. Variations

### 1. Embodiment

### Basic Description of Present Technology

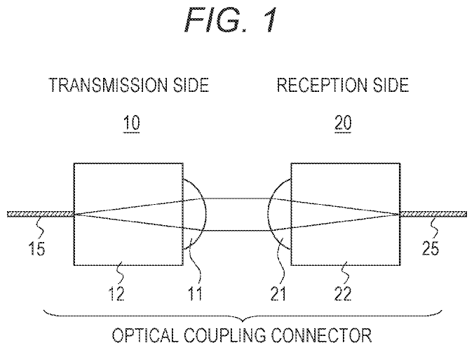

First, technology related to the present technology will be described. FIG. 1 outlines an optical connector of optical coupling type (hereinafter, referred to as an “optical coupling connector”). The optical coupling connector includes a transmission side optical connector 10 and a reception side optical connector 20.

The transmission side optical connector 10 includes a connector body 12 having a lens 11. The reception side optical connector 20 includes a connector body 22 having a lens 21. In a case where the transmission side optical connector 10 and the reception side optical connector 20 are connected, the lens 11 and the lens 21 face each other, and optical axes thereof match each other, as illustrated in the figure.

An optical fiber 15 is attached to the connector body 12 on the transmission side such that the emission end of the optical fiber 15 is located at the focal position on an optical axis of the lens 11. Furthermore, an optical fiber 25 is attached to the connector body 22 on the reception side such that the incident end of the optical fiber 25 is located at the focal position on an optical axis of the lens 21.

Light emitted from the optical fiber 15 on the transmission side is incident on the lens 11 via the connector body 12, and light that has been shaped into collimated light is emitted from the lens 11. The light that has been shaped into collimated light in such a way is incident on the lens 21 and collected, and then is incident on the incident end of the optical fiber 25 on the reception side via the connector body 22. As a result, light (optical signal) is transmitted from the optical fiber 15 on the transmission side to the optical fiber 25 on the reception side.

In an optical coupling connector as illustrated in FIG. 1, in a case where an optical fiber has an exceedingly small core diameter of approximately 8 μmcφ in a single mode, deviation of an optical-fiber optical path (optical-axis deviation) from a lens optical axis on the transmission side significantly influences the coupling loss of optical power on the reception side. As a result, in a case of the optical coupling connector, high parts precision is required in order to inhibit the axis deviation on the transmission side, which increases costs.

Increasing the focal distance of the lens 11 on the transmission side and increasing the distance from the lens 11 to a light source, that is, an emission end of the optical fiber 15 on the transmission side can be considered as a method of reducing the coupling loss of optical power on the reception side due to an optical-axis deviation on the transmission side.

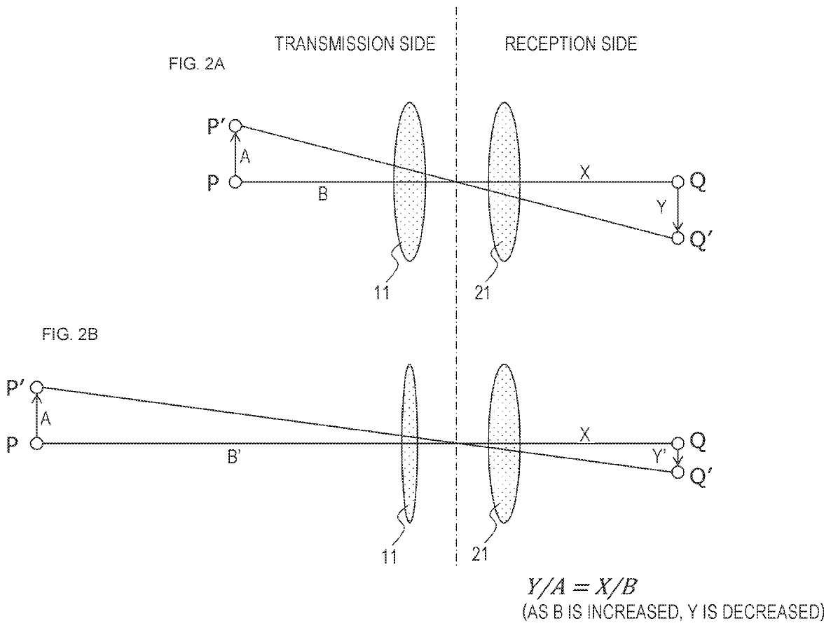

The case where light is transmitted from a light source P on the transmission side to a light collecting point Q on the reception side will be described. FIG. 2(a) illustrates a state in which the distance from the lens 11 to the light source P is not increased on the transmission side. In this case, if the position of the light source P on the transmission side is deviated to P′ by A, the position of the light collecting point Q on the reception side is deviated to Q′ by Y.

FIG. 2(b) illustrates a state in which the curvature of the lens 11 is softened to increase the focal distance, and the distance from the lens 11 to the light source P is increased on the transmission side. In this case, if the position of the light source P on the transmission side is deviated to P′ by A, the position of the light collecting point Q on the reception side is deviated to Q′ by Y′, and Y′ is smaller than Y.

Expression (1) below generally represents the relation between the light source P and the light collecting point Q. Here, A represents a position deviation amount of the light source P, B represents the distance from the light source P to the lens 11, X represents the distance from the lens 21 to the light collecting point Q, and Y represents a position deviation amount of the light collecting point Q. Expression (1) indicates that, if A is constant, Y can be reduced by increasing B. For example, if B is increased to B′, Y is decreased to Y′.

Y/A=X/B (1)

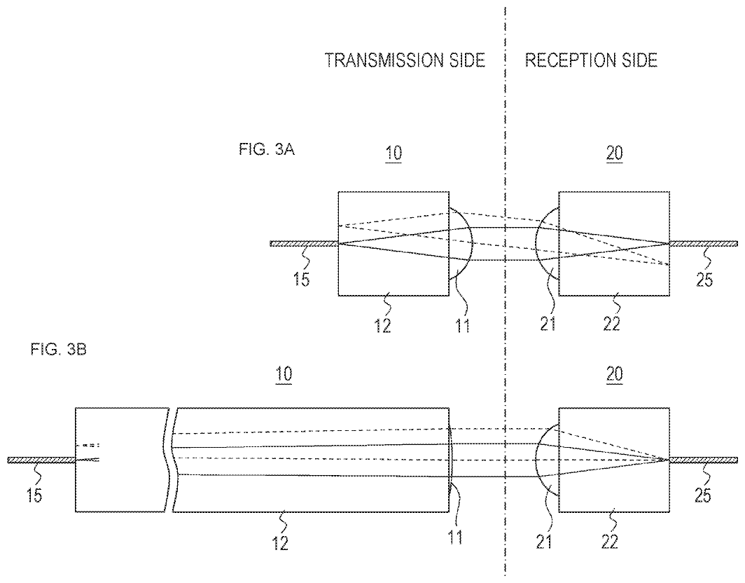

The theory described in FIGS. 2(a) and 2(b) will be considered with reference to an optical coupling connector using collimated light. As illustrated in FIG. 3(a), in a case where light emitted from the optical fiber 15 on the transmission side is used as a light source, the deviation of the position of the light source significantly deviates a light collecting point on the reception side (see broken lines). This is because light to be collimated by the lens 11 is thrown into disorder, so that the light is not parallel to the optical axis and is obliquely input to the lens 21 on the reception side, which deviates the light collecting point.

In contrast, as illustrated in FIG. 3(b), in a case where the distance between the light source and the lens 11 on the transmission side is long, the parallelism of collimated light with respect to the optical axis is less likely to be lost compared to the case of FIG. 3(a) even if the position of the light source is deviated since the incident angle of the light from the optical fiber 15 to the lens 11 is softened and the curvature of the lens 11 is also softened. As a result, the collimated light keeping the parallelism to the optical axis is incident on the lens 21 on the reception side, which prevents deviation of the light collecting point (see broken lines). This can reduce the coupling loss of optical power on the reception side due to an optical-axis deviation on the transmission side.

In a case where the distance between the light source and the lens 11 on the transmission side is increased as illustrated in FIG. 3(b), the numerical aperture (NA) for optical fibers has been uniquely determined. In a case where the diameter of collimated light is kept, the maximum distance from the light source to the lens 11 is limited by NA. Furthermore, even in a case of a light source with a small NA, increased distance from the light source to the lens 11 reduces the precision of aligning the center of the light source and that of the lens 11 at the time of manufacturing parts. This causes, for example, increase in the coupling loss of optical power on the reception side, further increase in costs for securing precision, or deterioration of usability due to an increased connector length.

### Configuration Example of Electronic Device and Optical Cable

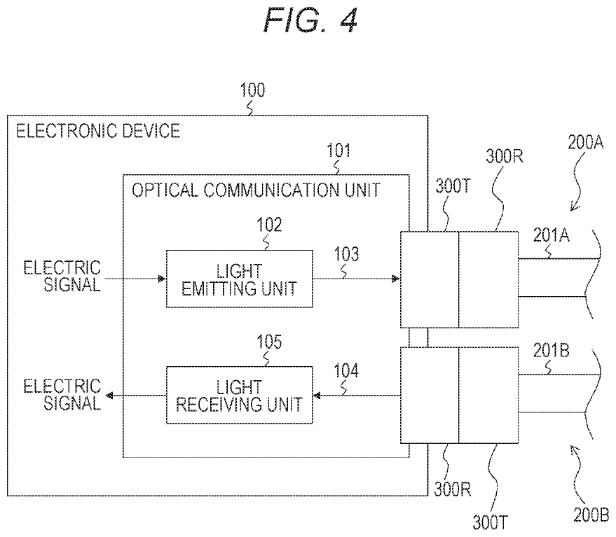

FIG. 4 illustrates a configuration example of an electronic device 100 and optical cables 200A and 200B as an embodiment. The electronic device 100 includes an optical communication unit 101. The optical communication unit 101 includes a light emitting unit 102, an optical transmission line 103, a transmission side optical connector 300T serving as a receptacle, a reception side optical connector 300R serving as a receptacle, an optical transmission line 104, and a light receiving unit 105. Each of the optical transmission lines 103 and 104 can be implemented by an optical fiber.

The light emitting unit 102 includes a laser element such as a vertical cavity surface emitting laser (VCSEL) or a light emitting element such as a light emitting diode (LED). The light emitting unit 102 converts an electric signal (transmission signal) generated in a transmission circuit (not illustrated) of the electronic device 100 into an optical signal. The optical signal emitted by the light emitting unit 102 is sent to the transmission side optical connector 300T via the optical transmission line 103. Here, the light emitting unit 102, the optical transmission line 103, and the transmission side optical connector 300T constitute an optical transmitter.

An optical signal received by the reception side optical connector 300R is sent to the light receiving unit 105 via the optical transmission line 104. The light receiving unit 105 includes a light receiving element such as a photodiode. The light receiving unit 105 converts an optical signal sent from the reception side optical connector 300R into an electric signal (reception signal), and supplies the converted signal to a reception circuit (not illustrated) of the electronic device 100. Here, the reception side optical connector 300R, the optical transmission line 104, and the light receiving unit 105 constitute an optical receiver.

The optical cable 200A includes the reception side optical connector 300R serving as a plug and a cable body 201A. The optical cable 200A transmits an optical signal from the electronic device 100 to another electronic device. The cable body 201A can be implemented by an optical fiber.

One end of the optical cable 200A is connected to the transmission side optical connector 300T of the electronic device 100 by the reception side optical connector 300R, and the other end of the optical cable 200A is connected to another electronic device (not illustrated). In this case, the transmission side optical connector 300T and the reception side optical connector 300R, which are connected to each other, constitute an optical coupling connector.

The optical cable 200B includes the transmission side optical connector 300T serving as a plug and a cable body 201B. The optical cable 200B transmits an optical signal from another electronic device to the electronic device 100. The cable body 201B can be implemented by an optical fiber.

One end of the optical cable 200B is connected to the reception side optical connector 300R of the electronic device 100 by the transmission side optical connector 300T, and the other end of the optical cable 200B is connected to another electronic device (not illustrated). In this case, the transmission side optical connector 300T and the reception side optical connector 300R, which are connected to each other, constitute an optical coupling connector.

Note that the electronic device 100 may be, for example, a mobile electronic device, such as a mobile phone, a smartphone, a PHS, a PDA, a tablet PC, a laptop computer, a video camera, an IC recorder, a portable media player, an electronic notebook, an electronic dictionary, a calculator, and a portable game machine, or another electronic device such as a desktop computer, a display apparatus, a TV receiver, a radio receiver, a video recorder, a printer, a car navigation system, a game machine, a router, a hub, and an optical network unit (ONU) Alternatively, the electronic device 100 can constitute a part or all of an electric product, such as a refrigerator, a washing machine, a clock, an interphone, an air conditioner, a humidifier, an air purifier, a lighting device, and a cooking device, and a vehicle as described later.

### Configuration Example of Optical Connector

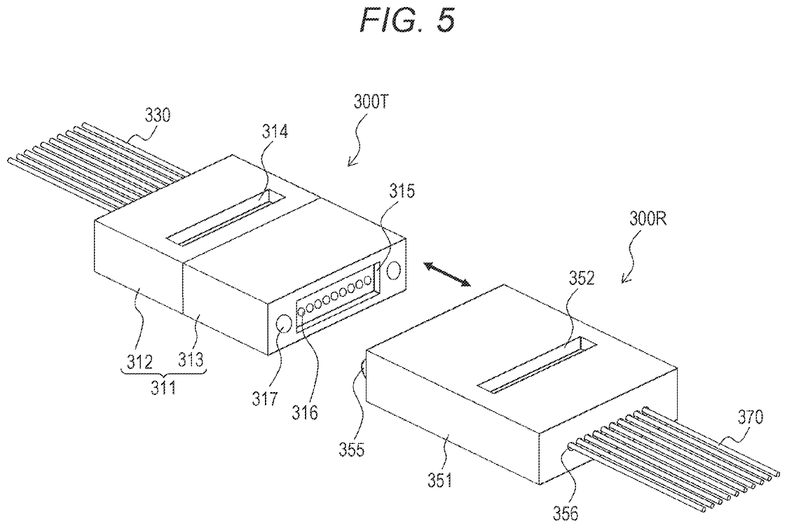

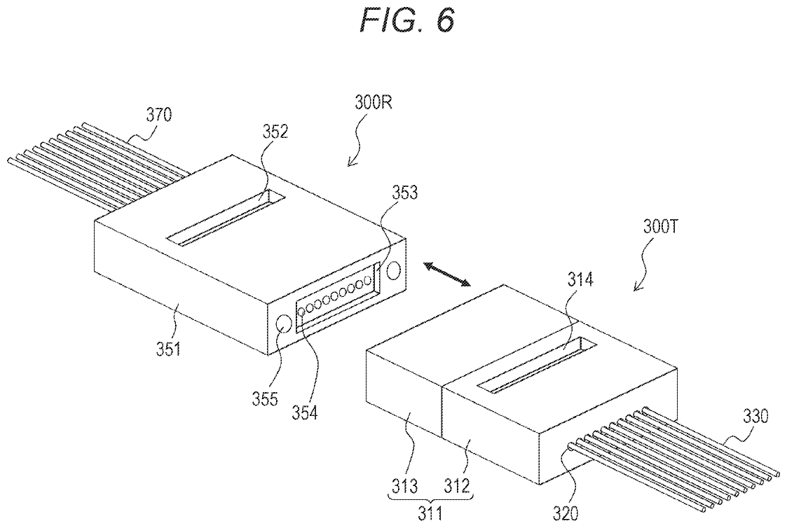

FIG. 5 is a perspective view illustrating one example of the transmission side optical connector 300T and the reception side optical connector 300R, which constitute an optical coupling connector. FIG. 6 is also a perspective view illustrating one example of the transmission side optical connector 300T and the reception side optical connector 300R, but is seen from the direction opposite to that of FIG. 5. The examples illustrate a parallel transmission of optical signals through a plurality of channels. Note that, although the parallel transmission of optical signals through a plurality of channels is illustrated here, transmission of an optical signal through one channel can be performed. The detailed description is omitted.

The transmission side optical connector 300T includes a connector body 311 having a substantially rectangular parallelepiped appearance. The connector body 311 is configured by connecting a first optical unit 312 and a second optical unit 313. The connector body 311 configured by the first and second optical units 312 and 313 as described above can facilitate, for example, manufacturing of a first lens (not illustrated in FIGS. 5 and 6).

A plurality of optical fibers 330 corresponding to individual channels is connected to the back surface side of the first optical unit 312 in a horizontally aligned state. In this case, each optical fiber 330 is fixed with the tip side thereof being inserted into an optical fiber insertion hole 320. Here, the optical fiber 330 constitutes a light-emitting body. Furthermore, an adhesive injection hole 314 having a rectangular opening is formed on the upper surface side of the first optical unit 312. An adhesive for fixing the optical fiber 330 to the first optical unit 312 is inserted through the adhesive injection hole 314.

A recessed light emitting portion (light transmission space) 315 having a rectangular opening is formed on the front surface side of the second optical unit 313. A plurality of second lenses (convex lens) 316 corresponding to individual channels is formed in a horizontally aligned state at a bottom portion of the light emitting portion 315. This configuration prevents the surface of the second lens 316 from being scratched by carelessly hitting against, for example, a connector on the other side.

Furthermore, a projecting or recessed (recessed in the illustrated example) position restricting portion 317 for performing positioning with the reception side optical connector 300R is integrally formed on the front surface side of the second optical unit 313. This configuration facilitates optical-axis alignment at the time of connection with the reception side optical connector 300R.

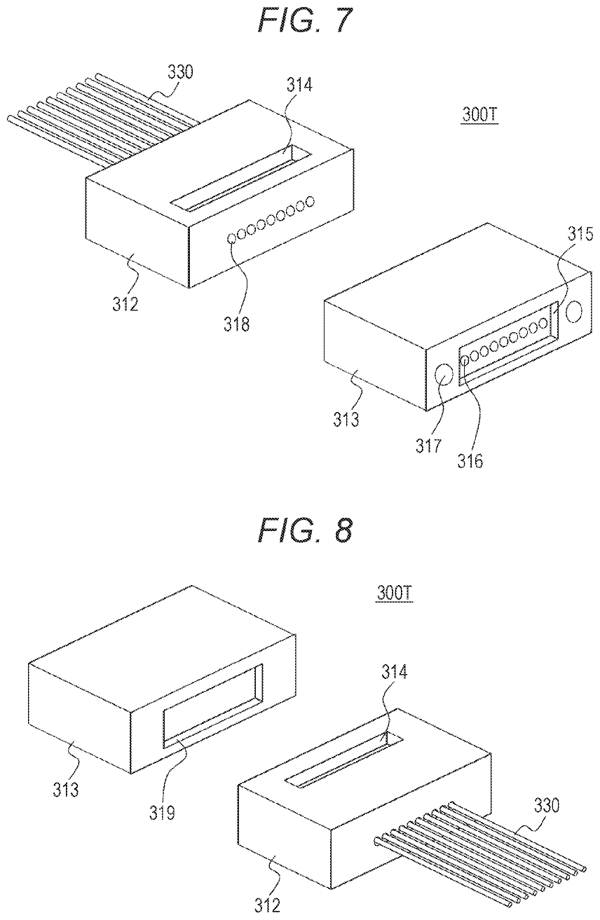

FIGS. 7 and 8 are perspective views illustrating a state in which the first optical unit 312 and the second optical unit 313, which constitute the connector body 311, are separated. FIGS. 7 and 8 are seen from opposite directions. A plurality of first lenses (convex lenses) 318 corresponding to individual channels is formed on the front surface side of the first optical unit 312 in a horizontally aligned state. Furthermore, recessed space 319 having a rectangular opening is formed on the back surface side of the second optical unit 313.

The first optical unit 312 and the second optical unit 313 are connected to constitute the connector body 311 (see FIGS. 5 and 6). In this case, the space 319 formed on the back surface side of the second optical unit 313 is sealed on the front surface side of the first optical unit 312 to be sealed space. Then, the first lens 318 formed on the front surface side of the first optical unit 312 is positioned in the sealed space 319. Positioning the first lens 318 in the sealed space 319 in such a way prevents, for example, mote and dirt from attaching to the surface of the first lens 318.

Returning to FIGS. 5 and 6, the reception side optical connector 300R includes a connector body 351 having a substantially rectangular parallelepiped appearance. A plurality of optical fibers 370 corresponding to individual channels is connected to the back surface side of the connector body 351. In this case, each optical fiber 370 is fixed with the tip side thereof being inserted into an optical fiber insertion hole 356. Furthermore, an adhesive injection hole 352 having a rectangular opening is formed on the upper surface side of the connector body 351. An adhesive for fixing the optical fiber 370 to the connector body 351 is inserted through the adhesive injection hole 352.

A recessed light incident portion (light transmission space) 353 having a rectangular opening is formed on the front surface side of the connector body 351. Lenses 354 corresponding to individual channels are positioned at a bottom portion of the light incident portion 353. This configuration prevents the surface of the lens 354 from being scratched by carelessly hitting against, for example, a connector on the other side.

Furthermore, a recessed or projecting (projecting in the illustrated example) position restricting portion 355 for performing positioning with the transmission side optical connector 300T is integrally formed on the front surface side of the connector body 351. This configuration facilitates optical-axis alignment at the time of connection with the transmission side optical connector 300T. Note that the position restricting portion 355 is not limited to being integrally formed with the connector body 351. The position restricting portion 355 may be formed with a pin or by another approach.

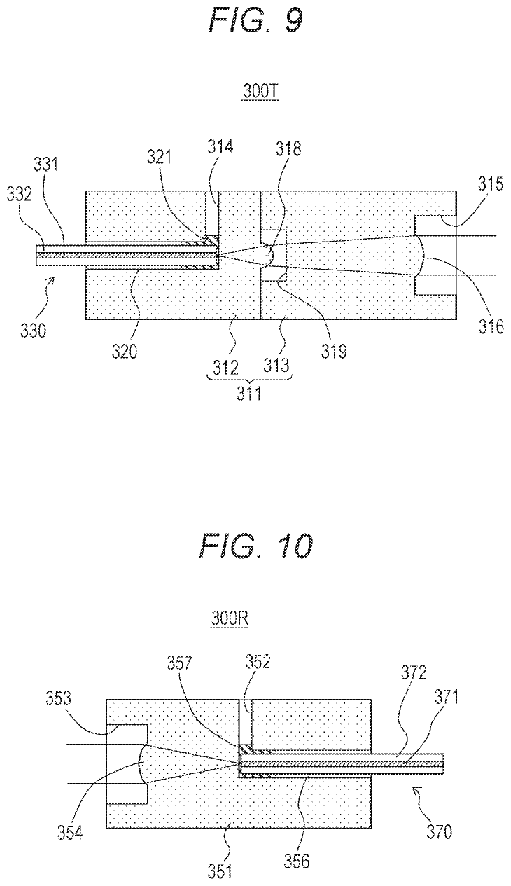

FIG. 9 is a cross-sectional view illustrating one example of the transmission side optical connector 300T. In the illustrated example, the description of the position restricting portion 317 (see FIG. 5) is omitted. The transmission side optical connector 300T will be further described with reference to FIG. 9.

The transmission side optical connector 300T includes the connector body 311 configured by connecting the first optical unit 312 and the second optical unit 313. The first optical unit 312 includes, for example, a light-transmitting material such as synthetic resin or glass, or a material such as silicon that transmits a specific wavelength, and is configured as a ferrule with a lens.

Such configuration of the first optical unit 312 as a ferrule with a lens can facilitate optical-axis alignment of the optical fiber 330 and the first lens 318. Furthermore, such configuration of the first optical unit 312 as a ferrule with a lens can facilitate multi-channel communication only by inserting the optical fiber 330 into the ferrule even in a case of multiple channels.

A plurality of first lenses 318 corresponding to individual channels is integrally formed on the front surface side of the first optical unit 312 in a horizontally aligned state. This configuration can increase the precision of the position of the first lens 318 with respect to a core 331 of the optical fiber 330 installed in the first optical unit 312 all at the same time in a plurality of channels. Furthermore, a plurality of optical fiber insertion holes 320 extending from the back surface side to the front is provided in the first optical unit 312 in a horizontally aligned state in accordance with the first lenses 318 of the channels. The optical fiber 330 has double structure of the core 331 in the center portion of an optical path and a clad 332 covering the periphery the core 331.

The optical fiber insertion hole 320 of each channel is shaped such that the core 331 of the optical fiber 330 to be inserted into the optical fiber insertion hole 320 and the optical axis of the corresponding first lens 318 match each other. Furthermore, the optical fiber insertion hole 320 of each channel is shaped such that the bottom position of the optical fiber insertion hole 320, that is, the abutting position of the tip (emission end) of the optical fiber 330 in a case where the optical fiber 330 is inserted matches the focal position of the first lens 318.

Furthermore, the adhesive injection hole 314 extending downward from the upper surface side is formed in the first optical unit 312 so as to communicate with the vicinity of the bottom position of a plurality of optical fiber insertion holes 320 in the horizontally aligned state. After the optical fiber 330 is inserted into the optical fiber insertion hole 320, an adhesive 321 is injected around the optical fiber 330 through the adhesive injection hole 314, whereby the optical fiber 330 is fixed to the first optical unit 312.

Here, if there is an air layer between the tip of the optical fiber 330 and the bottom position of the optical fiber insertion hole 320, light emitted from the optical fiber 330 easily reflects at the bottom position, which deteriorates signal quality. Therefore, the adhesive 321 is desirably a light transmitting agent, and injected between the tip of the optical fiber 330 and the bottom position of the optical fiber insertion hole 320. This configuration can reduce the reflection.

The second optical unit 313 includes, for example, a light-transmitting material such as synthetic resin or glass, or a material such as silicon that transmits a specific wavelength. The second optical unit 313 is connected to the first optical unit 312 to constitute the connector body 311. Since aligned thermal expansion coefficients inhibit optical-path deviation due to distortion at the two optical units at the time of thermal change, the material of the second optical unit 313 is preferably the same as the material of the first optical unit 312, but another material may be used.

The recessed light emitting portion (light transmission space) 315 is formed on the front surface side of the second optical unit 313. Then, a plurality of second lenses 316 corresponding to individual channels is integrally formed on the second optical unit 313 in a horizontally aligned state so as to be positioned at the bottom portion of the light emitting portion 315. This configuration can increase the precision of the position of the second lens 316 with respect to the second optical unit 313.

Furthermore, the recessed space 319 is formed on the back surface side of the second optical unit 313. The space 319 is sealed on the front surface side of the first optical unit 312 to be sealed space. In this case, the first lens 318 of each channel formed on the front surface side of the first optical unit 312 is positioned in the sealed space 319.

As described above, the first optical unit 312 and the second optical unit 313 are connected to constitute the connector body 311. For example, a method of newly providing a recessed portion on one side and a projecting portion on the other side and fitting these portions as in the case of a boss or a method of adhesion and fixation by matching optical-axis positions of lenses with, for example, an image processing system can be adopted as the connection method.

In the transmission side optical connector 300T, the first lens 318 has a function of converging light emitted from the optical fiber 330, which is a light-emitting body. Furthermore, the second lens 316 has a function of shaping the light converged by the first lens 318 into collimated light and emitting the collimated light. This causes light emitted from the emission end of the optical fiber 330 with a predetermined NA to be incident on the first lens 318 and converged (angle is narrowed). The converged light is incident on the second lens 316, shaped into collimated light, and then emitted.

FIG. 10 is a cross-sectional view illustrating one example of the reception side optical connector 300R. In the illustrated example, the description of the position restricting portion 355 (see FIGS. 5 and 6) is omitted. The reception side optical connector 300R will be further described with reference to FIG. 10.

The reception side optical connector 300R includes the connector body 351. The connector body 351 includes, for example, a light-transmitting material such as synthetic resin or glass, or a material such as silicon that transmits a specific wavelength, and is configured as a ferrule with a lens.

The recessed light incident portion (light transmission space) 353 is formed on the front surface side of the connector body 351. Then, a plurality of lenses (convex lens) 354 corresponding to individual channels is integrally formed on the connector body 351 in a horizontally aligned state so as to be positioned at the bottom portion of the light incident portion 353.

Furthermore, a plurality of optical fiber insertion holes 356 extending from the back surface side to the front is provided in the connector body 351 in a horizontally aligned state in accordance with the lenses 354 of the channels. The optical fiber 370 has double structure of the core 371 in the center portion of an optical path and a clad 372 covering the periphery of the core 371.

The optical fiber insertion hole 356 of each channel is shaped such that the core 371 of the optical fiber 370 to be inserted into the optical fiber insertion hole 356 and the optical axis of the corresponding lens 354 match each other. Furthermore, the optical fiber insertion hole 356 of each channel is shaped such that the bottom position of the optical fiber insertion hole 356, that is, the abutting position of the tip (emission end) of the optical fiber 370 in a case where the optical fiber 370 is inserted matches the focal position of the lens 354.

Furthermore, the adhesive injection hole 352 extending downward from the upper surface side is formed in the connector body 351 so as to communicate with the vicinity of the bottom position of a plurality of optical fiber insertion holes 356 in the horizontally aligned state. After the optical fiber 370 is inserted into the optical fiber insertion hole 356, an adhesive 357 is injected around the optical fiber 370 through the adhesive injection hole 352, whereby the optical fiber 370 is fixed to the connector body 351.

In the reception side optical connector 300R, the lens 354 has a function of collecting incident collimated light. In this case, the collimated light is incident on the lens 354 and collected. The collected light is incident on the incident end of the optical fiber 370, which is a light receiver, with a predetermined NA.

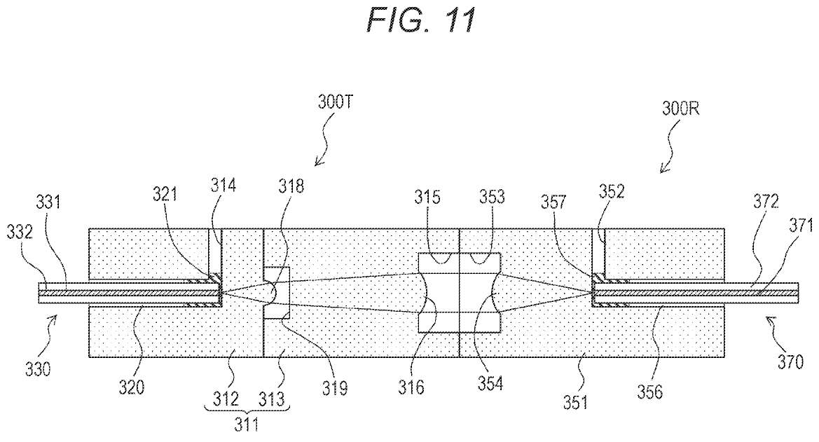

FIG. 11 is a cross-sectional view of the transmission side optical connector 300T and the reception side optical connector 300R, which constitute an optical coupling connector. In the illustrated example, the transmission side optical connector 300T and the reception side optical connector 300R are connected with each other.

In the transmission side optical connector 300T, light sent through the optical fiber 330 is emitted from the emission end of the optical fiber 330 with a predetermined NA. The emitted light is incident on the first lens 318, and converged. Then, the converged light is incident on the second lens 316 to be shaped into collimated light. The collimated light is emitted toward the reception side optical connector 300R.

Furthermore, in the reception side optical connector 300R, light emitted from the transmission side optical connector 300T is incident on the lens 354, and collected. Then, the collected light is incident on the incident end of the optical fiber 370, and sent through the optical fiber 370.

In the optical coupling connector configured as described above, the transmission side optical connector 300T converges light emitted from the optical fiber 330 serving as a light-emitting body with the first lens 318, shapes the converged light into collimated light with the second lens 316, and emits the collimated light. Therefore, coupling loss of optical power on the reception side due to axis deviation on the transmission side can be mitigated by inhibiting the increase in distance from the optical fiber 330 to the second lens 316, restricting the diameter of light from the optical fiber 330 such that the diameter is within the diameter of the second lens 316, and increasing the focal distance of the second lens 316. Here, increasing the focal distance of the second lens 316 softens the angle of light incident on the second lens 316 and the curvature of the second lens 316, which inhibits the deviation of the light collecting point on the reception side due to the axis deviation on the transmission side.

A simulation result of an effect of the present technology will be described. Here, an optical system having an optical fiber with an NA of 0.15 and a collimating diameter of 180 μm is used. The optical fiber has a mode field diameter (MFD) of 8 μm. FIG. 12(a) illustrates a configuration example of a common transmission side optical connector. FIG. 12(b) illustrates a configuration example of a transmission side optical connector according to the present technology. Note that the reception side optical connector has the same configuration as the conventional transmission side optical connector in FIG. 12(a).

The graph of FIG. 13 illustrates a simulation result of the coupling efficiency of light input to the optical fiber on the reception side. The horizontal axis represents an axis deviation amount, that is, a deviation amount in a case where a light source is deviated vertically to the optical axis. The vertical axis represents the coupling efficiency of light on the reception side. A solid line (a) represents the relation between the axis deviation amount and the coupling efficiency in a case where the common transmission side optical connector in FIG. 12(a) is used. A solid line (b) represents the relation between the axis deviation amount and the coupling efficiency in a case where the transmission side optical connector according to the present technology in FIG. 12(b) is used.

Since the optical fiber has an MFD of 8 μm, for example, an axis deviation amount of 5 μm causes power loss of approximately 75 percent of the solid line (a) in a case where the common transmission side optical connector in FIG. 12(a) is used. In contrast, in a case where the transmission side optical connector according to the present technology in FIG. 12(b) is used, the power loss is approximately 10 percent of the solid line (b). Power loss is significantly reduced.

Note that the effects described in the specification are merely illustration and not limitation, and additional effects may be exhibited.

### Other Configuration Examples of Transmission Side Optical Connector

Other various configurations can be considered as the configuration of the transmission side optical connector in addition to the above-described transmission side optical connector 300T (see FIG. 9).

### Another Configuration Example 1

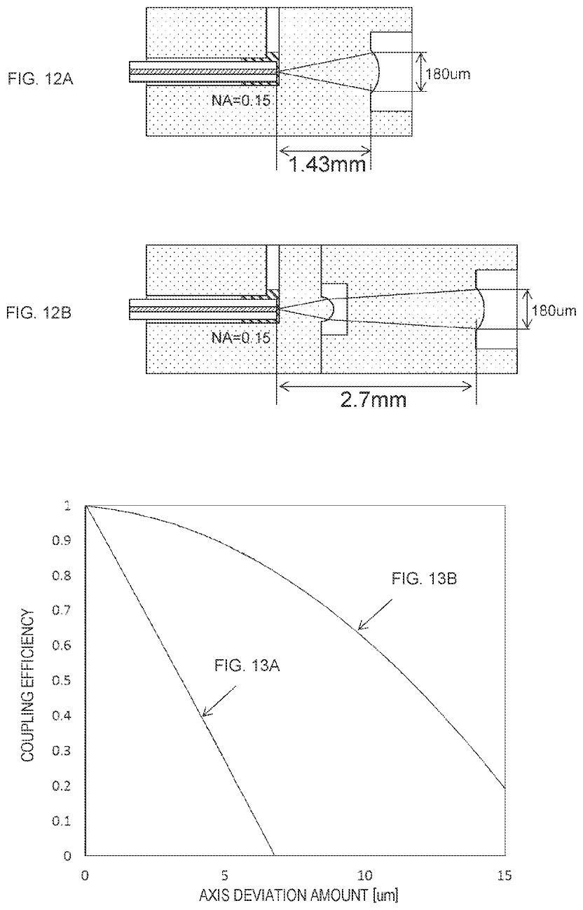

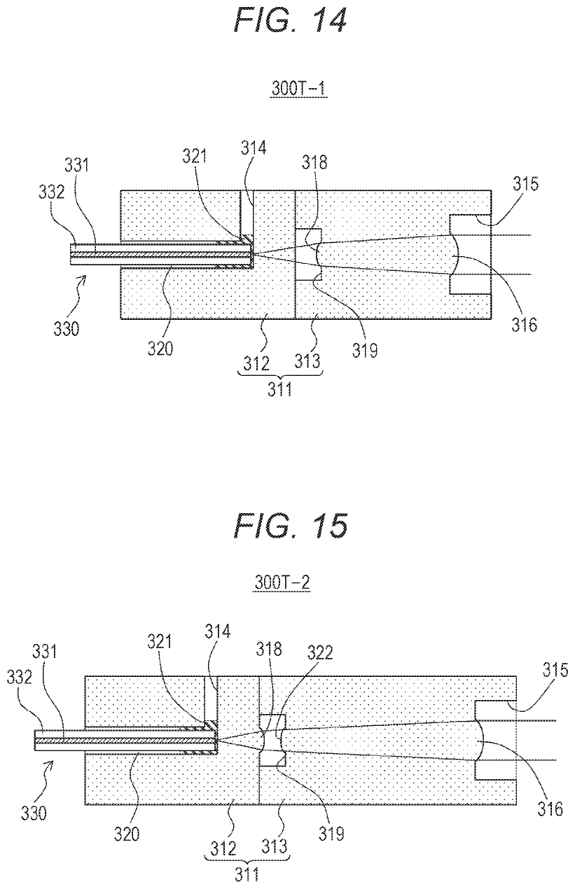

FIG. 14 is a cross-sectional view illustrating a transmission side optical connector 300T-1 in another configuration example 1. In FIG. 14, the same sign is attached to a portion corresponding to that in FIG. 9, and detailed description thereof will be omitted as appropriate. In the transmission side optical connector 300T-1, the first lens 318 is formed not on the front surface side of the first optical unit 312 but at the bottom portion of the space 319 formed on the back surface side of the second optical unit 313.

In this case, at the time when the first optical unit 312 and the second optical unit 313 are connected with each other, the space 319 formed on the back surface side of the second optical unit 313 is sealed on the front surface side of the first optical unit 312 to be sealed space. Therefore, also in the transmission side optical connector 300T-1, in a manner similar to the transmission side optical connector 300T in FIG. 9, the first lens 318 is positioned in the sealed space 319, and attachment of, for example, mote and dirt on the surface can be prevented.

### Another Configuration Example 2

FIG. 15 is a cross-sectional view illustrating a transmission side optical connector 300T-2 in another configuration example 2. In FIG. 15, the same sign is attached to a portion corresponding to that in FIG. 9, and detailed description thereof will be omitted as appropriate. In the transmission side optical connector 300T-2, a second first lens (convex lens) 322 is formed at the bottom portion of the space 319 formed on the back surface side of the second optical unit 313.

In the transmission side optical connector 300T-2, light emitted from the emission end of the optical fiber 330 with a predetermined NA is incident on the first lens 318 and converged (angle is narrowed). The converged light is incident on the second first lens 322 and further converged (angle is narrowed). The converged light is incident on the second lens 316, shaped into collimated light, and then emitted.

In a case of the transmission side optical connector 300T-2, the angles of the two first lenses 318 and 322 are continuously narrowed. Thus, the spherical height of each of the two first lenses 318 and 322 can be reduced, and a lens can be easily shaped. Furthermore, also in the transmission side optical connector 300T-2, in a manner similar to the transmission side optical connector 300T in FIG. 9, the two first lenses 318 and 322 are positioned in the sealed space 319, and attachment of, for example, mote and dirt on the surface can be prevented.

Note that an example in which the two first lenses 318 and 322 are provided has been described above. Although detailed description is omitted, placing more lenses on the optical axis as the first lenses can be considered.

### Another Configuration Example 3

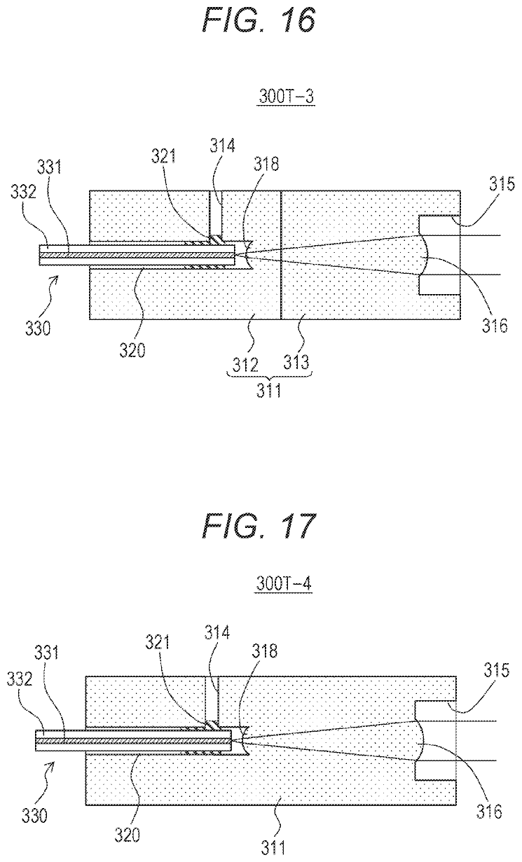

FIG. 16 is a cross-sectional view illustrating a transmission side optical connector 300T-3 in another configuration example 3. In FIG. 16, the same sign is attached to a portion corresponding to that in FIG. 9, and detailed description thereof will be omitted as appropriate. In the transmission side optical connector 300T-3, the first lens 318 is formed not on the front surface side of the first optical unit 312 but at the innermost bottom portion of the optical fiber insertion hole 320. Forming the first lens 318 at the bottom portion of the optical fiber insertion hole 320 in such a way can increase the precision of optical-axis alignment of the optical fiber 330 and the first lens 318.

In this case, it is necessary to fix the optical fiber 330 to be inserted into the fiber insertion hole 320 with the tip of the optical fiber 330 not abutting on the bottom portion of the fiber insertion hole 320 but being kept separated from the bottom portion by a certain distance, that is, being positioned at the focal position of the first lens 318.

Furthermore, in this case, if the adhesive 321 enters the space between the tip of the optical fiber 330 and the first lens 318 at the time of attaching and fixing the optical fiber 330 to the first optical unit 312, optical characteristics change. For that reason, the adhesive injection hole 314 for injecting the adhesive 321 needs to be formed at a position other than a tip portion of the optical fiber 330. The adhesive injection hole 314 needs to be formed such that the adhesive 321 does not enter the space between the tip of the optical fiber 330 and the first lens 318.

### Another Configuration Example 4

FIG. 17 is a cross-sectional view illustrating a transmission side optical connector 300T-4 in another configuration example 4. In FIG. 17, the same sign is attached to a portion corresponding to those in FIGS. 9 and 16, and detailed description thereof will be omitted as appropriate. In the transmission side optical connector 300T-4, the connector body 311 includes one optical unit. This is possible because the first lens 318 formed at the bottom portion of the optical fiber insertion hole 320 eliminates the need to make the space 319 in the optical unit.

### Another Configuration Example 5

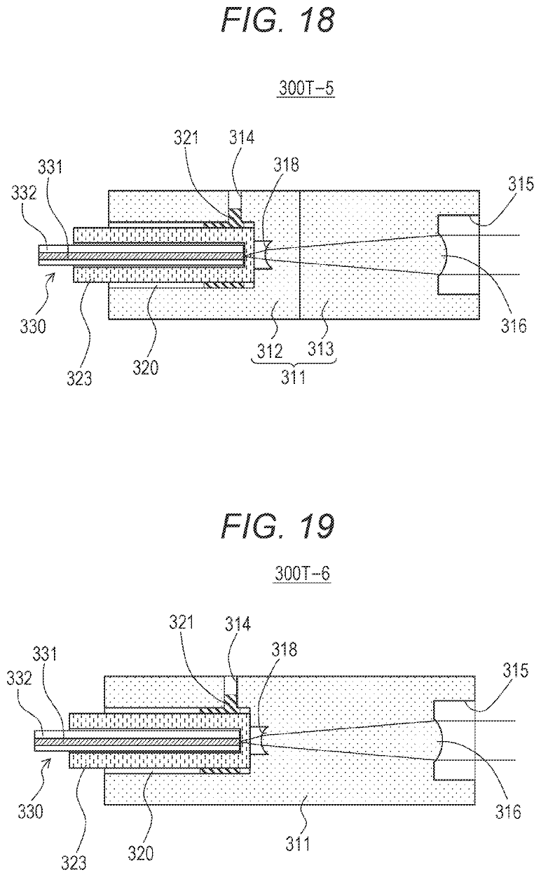

FIG. 18 is a cross-sectional view illustrating a transmission side optical connector 300T-5 in another configuration example 5. In FIG. 18, the same sign is attached to a portion corresponding to those in FIGS. 9 and 16, and detailed description thereof will be omitted as appropriate. In the transmission side optical connector 300T-5, the diameter of the optical fiber insertion hole 320 formed in the first optical unit 312 is increased. Then, a ferrule 323 to which the optical fiber 330 has been preliminarily fixed by abutting is inserted into the optical fiber insertion hole 320, and fixed by the adhesive 321. Such configuration makes it easy to keep the tip of the optical fiber 330 a certain distance away from the first lens 318.

### Another Configuration Example 6

FIG. 19 is a cross-sectional view illustrating a transmission side optical connector 300T-6 in another configuration example 6. In FIG. 19, the same sign is attached to a portion corresponding to those in FIGS. 9, 16, and 18, and detailed description thereof will be omitted as appropriate. In the transmission side optical connector 300T-6, the connector body 311 includes one optical unit. Other portions are configured in a manner similar to that of the transmission side optical connector 300T-5 in FIG. 18.

### Another Configuration Example 7

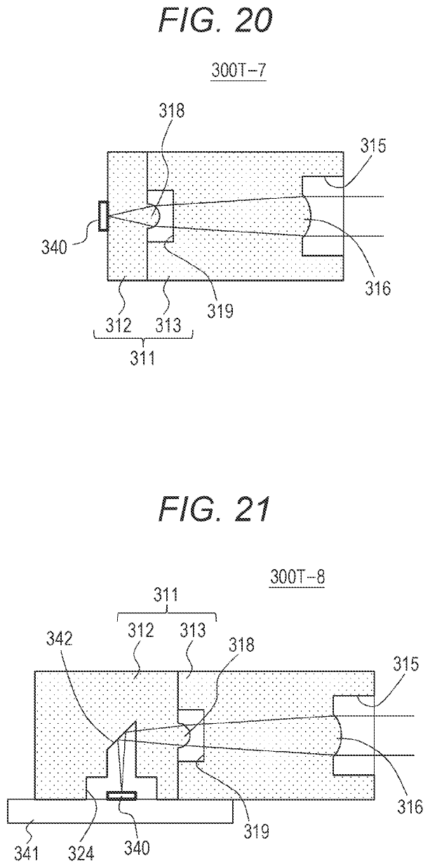

FIG. 20 is a cross-sectional view illustrating a transmission side optical connector 300T-7 in another configuration example 7. In FIG. 20, the same sign is attached to a portion corresponding to that in FIG. 9, and detailed description thereof will be omitted as appropriate. In the transmission side optical connector 300T-7, the light-emitting body fixed to the first optical unit 312 is not the optical fiber 330 but a light emitting element 340 such as a vertical cavity surface emitting laser (VCSEL).

In this case, a plurality of light emitting elements 340 is fixed to the back surface side of the first optical unit 312 in a horizontally aligned state in accordance with the first lens 318 of each channel. Then, in this case, the light emitting element 340 of each channel is fixed such that the emission portion of the light emitting element 340 matches the optical axis of the corresponding first lens 318. Furthermore, in this case, for example, the thickness of the first optical unit 312 in the optical-axis direction is set such that the emission portion of the light emitting element 340 of each channel matches the focal position of the corresponding first lens 318.

In the transmission side optical connector 300T-7, light emitted from the emission portion of the light emitting element 340 with a predetermined NA is incident on the first lens 318 and converged (angle is narrowed). The converged light is incident on the second lens 316, shaped into collimated light, and then emitted.

Fixing the light emitting element 340 to the first optical unit 312 in such a way eliminates the need for an optical fiber at the time when an optical signal is transmitted from the light emitting element 340, which can reduce costs.

### Another Configuration Example 8

FIG. 21 is a cross-sectional view illustrating a transmission side optical connector 300T-8 in another configuration example 8. In FIG. 21, the same sign is attached to a portion corresponding to those in FIGS. 9 and 20, and detailed description thereof will be omitted as appropriate. In the transmission side optical connector 300T-8, a substrate 341 on which the light emitting element 340 is mounted is fixed to the lower surface side of the connector body 311. In this case, a plurality of light emitting elements 340 is mounted on the substrate 341 in a horizontally aligned state in accordance with the first lens 318 of each channel.

A hole 324 for placing a light emitting element extending upward from the lower surface side is formed in the first optical unit 312. Then, the bottom portion of the hole 324 for placing a light emitting element is made to be an inclined surface in order to change the direction of an optical path of light from the light emitting element 340 of each channel into a direction of the corresponding first lens 318. A mirror 342 is placed on the inclined surface. Note that a separately generated mirror 342 may be not only fixed on the inclined surface but formed on the inclined surface by, for example, vapor deposition.

Here, the position of the substrate 341 is adjusted and the substrate 341 is fixed such that the emission portion of the light emitting element 340 of each channel matches the optical axis of the corresponding first lens 318. Furthermore, in this case, for example, the formation position of the first lens 318 and the formation position/length of the hole 324 for placing a light emitting element are set such that the emission portion of the light emitting element 340 of each channel matches the focal position of the corresponding first lens 318.

In the transmission side optical connector 300T-8, light emitted from the emission portion of the light emitting element 340 with a predetermined NA is incident on the first lens 318 and converged (angle is narrowed) after the optical path is changed by the mirror 342. The converged light is incident on the second lens 316, shaped into collimated light, and then emitted.

Fixing the substrate 341, on which the light emitting element 340 is mounted, to the connector body 311 in such a way eliminates the need for an optical fiber at the time when an optical signal is transmitted from the light emitting element 340, which can reduce costs. Furthermore, the configuration in which light from the light emitting element 340 mounted on the substrate 341 is incident on the first lens 318 after the optical path is changed by the mirror 342 facilitates mounting, and can increase the degree of freedom in design.

### Another Configuration Example 9

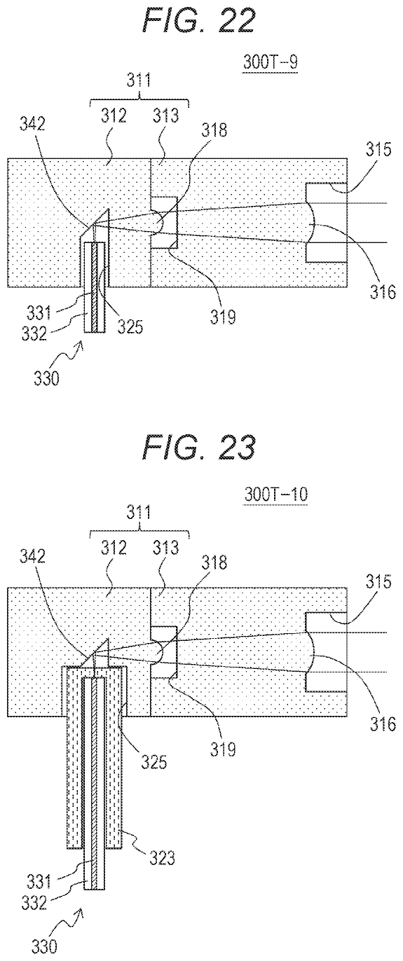

FIG. 22 is a cross-sectional view illustrating a transmission side optical connector 300T-9 in another configuration example 9. In FIG. 22, the same sign is attached to a portion corresponding to those in FIGS. 9 and 21, and detailed description thereof will be omitted as appropriate. In the transmission side optical connector 300T-9, a plurality of optical fiber insertion holes 325 extending upward from the lower surface side is formed in the first optical unit 312 in a horizontally aligned state in accordance with the first lenses 318 of the channels.

The bottom portion of each optical fiber insertion hole 325 is made to be an inclined surface in order to change the direction of an optical path of light from the optical fiber 330 to be inserted into each optical fiber insertion hole 325 into a direction of the corresponding first lens 318. A mirror 342 is placed on the inclined surface. Furthermore, each optical fiber insertion hole 325 is shaped such that the core 331 of the optical fiber 330 to be inserted into the optical fiber insertion hole 325 and the optical axis of the corresponding first lens 318 match each other.

The optical fiber 330 of each corresponding channel is inserted into each optical fiber insertion hole 325. The optical fiber 330 is fixed by, for example, injecting an adhesive (not illustrated) around the optical fiber 330. In this case, the insertion position of the optical fiber 330 is set such that the tip (emission end) thereof matches the focal position of the corresponding first lens 318, thus, such that the tip (emission end) thereof is positioned a certain distance away from the mirror 342.

In the transmission side optical connector 300T-9, light emitted from the emission end of the optical fiber 330 with a predetermined NA is incident on the first lens 318 and converged (angle is narrowed) after the optical path is changed by the mirror 342. The converged light is incident on the second lens 316, shaped into collimated light, and then emitted.

In a case of the configuration example, the configuration of the first optical unit 312 as a ferrule with a lens can facilitate optical-axis alignment of the optical fiber 330 and the first lens 318. Furthermore, in a case of the configuration example, the configuration in which an optical path of light from the optical fiber 330 is changed by the mirror 342 facilitates mounting, and can increase the degree of freedom in design.

### Another Configuration Example 10

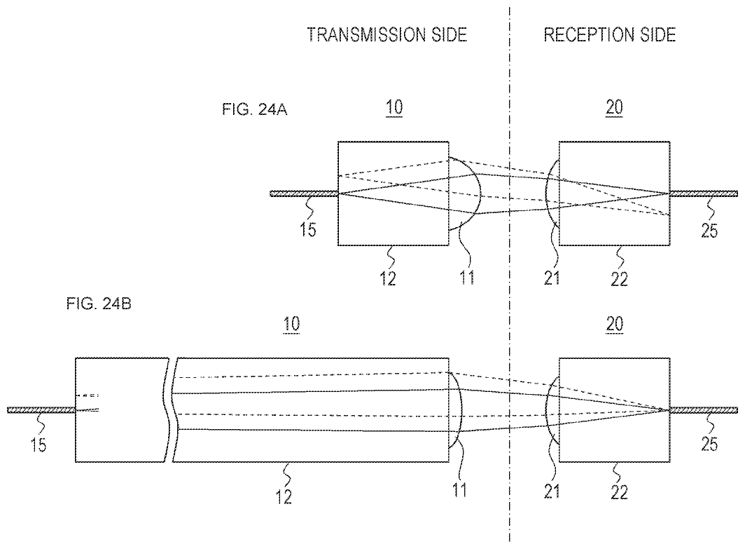

FIG. 23 is a cross-sectional view illustrating a transmission side optical connector 300T-10 in another configuration example 10. In FIG. 23, the same sign is attached to a portion corresponding to those in FIGS. 9, 18, and 22, and detailed description thereof will be omitted as appropriate. In the transmission side optical connector 300T-10, the diameter of the optical fiber insertion hole 325 formed in the first optical unit 312 is increased. Then, the ferrule 323 to which the optical fiber 330 has been preliminarily fixed by abutting is inserted into the optical fiber insertion hole 325, and fixed by, for example, an adhesive (not illustrated). Such configuration makes it easy to keep the tip position of the optical fiber 330 a certain distance away from the mirror 342.

### 2. Variations

Note that, although an example in which an optical fiber of single mode is used has been described in the above-described embodiment, the present technology can be similarly applied to the case where an optical fiber of multi-mode is used, and is not limited to a specific NA. Furthermore, the mirror in the above-described embodiment may be implemented by another optical path changing unit. For example, an optical path changing unit utilizing total reflection using the difference in refractive index can be considered.

Furthermore, an example in which the second lens 316 on the transmission side shapes collimated light has been described in the above-described embodiment, this is not limitative. FIG. 24 illustrates an optical coupling connector that uses not collimated light but convergent light (light bent in a light collecting direction). In FIG. 24, the same sign is attached to a portion corresponding to that in FIG. 3.

As illustrated in FIG. 24(a), in a case where light emitted from the optical fiber 15 on the transmission side is used as a light source, the deviation of the position of the light source significantly deviates a light collecting point on the reception side (see broken lines). This is because the convergent light in the lens 11 is thrown into disorder and obliquely input to the lens 21 on the reception side, which deviates a light collecting point.

In contrast, as illustrated in FIG. 24(b), in a case where the distance between the light source and the lens 11 on the transmission side is long, the incident angle of the light from the optical fiber 15 to the lens 11 is softened and the curvature of the lens 11 is also softened as compared to the case of FIG. 24(a) even if the position of the light source is deviated. As a result, the disorder of convergent light is inhibited, and deviation of a light collecting point is prevented (see broken lines). As a result, the coupling loss of optical power on the reception side due to an optical-axis deviation on the transmission side can be reduced by increasing the distance between the light source and the lens 11 on the transmission side even not in a case where the lens 11 shapes collimated light.

Although the preferred embodiment of the disclosure has been described in detail above with reference to the accompanying drawings, the technical scope of the disclosure is not limited to such an example. It is obvious that a person having ordinary skill in the art of the disclosure can arrive at various alternations or modifications within the scope of the technical ideas set forth in the claims. These alternations or modifications are understood to naturally fall within the technical scope of the disclosure.

Furthermore, the effects described herein are merely illustrative or exemplary, and not limitative. That is, the technique according to the disclosure may have other effects that are obvious to a skilled person from the description of the specification, together with or in place of the above-described effects.

Note that the present technology can also have the configurations as follows.

(1) An optical connector including

a connector body including a first lens that converges light emitted from a light-emitting body and a second lens that shapes light converged by the first lens and emits the light.

(2) The optical connector according to (1),

in which the connector body has sealed space, and

the first lens is positioned in the sealed space.

(3) The optical connector according to (1) or (2),

in which the first lens includes one or two or more lenses.

(4) The optical connector according to any one of claims (1) to (3),

in which the connector body includes a first optical unit on which light emitted from the light-emitting body is incident and a second optical unit including the second lens.

(5) The optical connector according to (4),

in which the first lens is included in the first optical unit and/or the second optical unit.

(6) The optical connector according to any one of (1) to (5),

in which the light-emitting body is an optical fiber, and

the connector body has an insertion hole into which the optical fiber is inserted.

(7) The optical connector according to (6),

in which the first lens is placed at a bottom portion of the insertion hole.

(8) The optical connector according to (7),

in which a ferrule into which the optical fiber is inserted and fixed is inserted into the insertion hole.

(9) The optical connector according to any one of (6) to (8),

in which the connector body includes an optical path changing unit that changes an optical path toward a bottom portion of the insertion hole, and light emitted from the optical fiber is incident on the first lens after the optical path is changed by the optical path changing unit.

(10) The optical connector according to any one of (1) to (5),

in which the light-emitting body is a light emitting element that converts an electric signal into an optical signal.

(11) The optical connector according to (10),

in which the light emitting element is connected to the connector body, and

light emitted from the light emitting element is incident on the first lens without change of an optical path.

(12) The optical connector according to (10),

in which the connector body includes an optical path changing unit that changes an optical path,

the light emitting element is fixed on a substrate, and

light emitted from the light emitting element is incident on the first lens after the optical path is changed by the optical path changing unit.

(13) The optical connector according to any one of (1) to (12),

in which the second lens shapes light emitted from the first lens into collimated light.

(14) The optical connector according to any one of (1) to (13),

in which the connector body

includes a light-transmitting material, and

integrally includes the first lens and the second lens.

(15) The optical connector according to any one of (1) to (14),

in which the connector body includes a plurality of combinations of the first lens and the second lens.

(16) The optical connector according to any one of (1) to (15),

in which the connector body includes a recessed light emitting portion, and

the second lens is positioned at a bottom portion of the light emitting portion.

(17) The optical connector according to any one of (1) to (16),

in which the connector body integrally includes, on a front surface side, a projecting or recessed position restricting portion that is used for position alignment with a connector on a side to be connected.

(18) The optical connector according to any one of (1) to (17), further including

the light-emitting body.

(19) An optical cable including an optical connector serving as a plug,

in which the optical connector includes

a connector body including a first lens that converges light emitted from a light-emitting body and a second lens that shapes light converged by the first lens and emits the light.

(20) An electronic device including an optical connector serving as a receptacle,

in which the optical connector includes

a connector body including a first lens that converges light emitted from a light-emitting body and a second lens that shapes light converged by the first lens and emits the light.

### REFERENCE SIGNS LIST

100 Electronic device
101 Optical communication unit
102 Light emitting unit
103, 104 Optical transmission line
105 Light receiving unit
200A, 200B Optical cable
201A, 201B Cable body
300T, 300T-1 to 300T-10 Transmission side optical connector
300R Reception side optical connector
311 Connector body
312 First optical unit
313 Second optical unit
314 Adhesive injection hole
315 Light emitting portion
316 Second lens
317 Position restricting portion
318 First lens
319 Space (sealed space)
320 Optical fiber insertion hole

### 321 Adhesive

322 First lens

### 323 Ferrule

324 Hole for placing light emitting element
325 Optical fiber insertion hole
330 Optical fiber

### 331 Core

340 Light emitting element

### 341 Substrate

### 342 Mirror

### 332 Clad

351 Connector body
352 Adhesive insertion hole
353 Light incident portion

### 354 Lens

355 Position restricting portion
356 Optical fiber insertion hole

### 357 Adhesive

370 Optical fiber

### 371 Core

### 372 Clad

1. An optical connector comprising
a connector body including a first lens that converges light emitted from a light-emitting body and a second lens that shapes light converged by the first lens and emits the light.

2. The optical connector according to claim 1,
wherein the connector body has sealed space, and
the first lens is positioned in the sealed space.

3. The optical connector according to claim 1,
wherein the first lens includes one or two or more lenses.

4. The optical connector according to claim 1,
wherein the connector body includes a first optical unit on which light emitted from the light-emitting body is incident and a second optical unit including the second lens.

5. The optical connector according to claim 4,
wherein the first lens is included in the first optical unit and/or the second optical unit.

6. The optical connector according to claim 1,
wherein the light-emitting body is an optical fiber, and
the connector body has an insertion hole into which the optical fiber is inserted.

7. The optical connector according to claim 6,
wherein the first lens is placed at a bottom portion of the insertion hole.

8. The optical connector according to claim 7,
wherein a ferrule into which the optical fiber is inserted and fixed is inserted into the insertion hole.

9. The optical connector according to claim 6,
wherein the connector body includes an optical path changing unit that changes an optical path toward a bottom portion of the insertion hole, and light emitted from the optical fiber is incident on the first lens after the optical path is changed by the optical path changing unit.

10. The optical connector according to claim 1,
wherein the light-emitting body is a light emitting element that converts an electric signal into an optical signal.

11. The optical connector according to claim 10,
wherein the light emitting element is connected to the connector body, and
light emitted from the light emitting element is incident on the first lens without change of an optical path.

12. The optical connector according to claim 10,
wherein the connector body includes an optical path changing unit that changes an optical path,
the light emitting element is fixed on a substrate, and
light emitted from the light emitting element is incident on the first lens after the optical path is changed by the optical path changing unit.

13. The optical connector according to claim 1,
wherein the second lens shapes light emitted from the first lens into collimated light.

14. The optical connector according to claim 1,
wherein the connector body
includes a light-transmitting material, and
integrally includes the first lens and the second lens.

15. The optical connector according to claim 1,
wherein the connector body includes a plurality of combinations of the first lens and the second lens.

16. The optical connector according to claim 1,
wherein the connector body includes a recessed light emitting portion, and
the second lens is positioned at a bottom portion of the light emitting portion.

17. The optical connector according to claim 1,
wherein the connector body integrally includes, on a front surface side, a projecting or recessed position restricting portion that is used for position alignment with a connector on a side to be connected.

18. The optical connector according to claim 1, further comprising
the light-emitting body.

19. An optical cable comprising an optical connector serving as a plug,
wherein the optical connector includes
a connector body including a first lens that converges light emitted from a light-emitting body and a second lens that shapes light converged by the first lens and emits the light.

20. An electronic device comprising an optical connector serving as a receptacle,
wherein the optical connector includes
a connector body including a first lens that converges light emitted from a light-emitting body and a second lens that shapes light converged by the first lens and emits the light.
